(19) United States
(12) Patent Application Publication
(10) Pub. No.: US 2024/0160487 A1
(43) Pub. Date: May 16, 2024

(54) FLEXIBLE GPU RESOURCE SCHEDULING METHOD IN LARGE-SCALE CONTAINER OPERATION ENVIRONMENT

(71) Applicant: Korea Electronics Technology Institute, Seongnam-si (KR)

(72) Inventors: Jae Hoon AN, Incheon (KR); Young Hwan KIM, Yongin-si (KR); Ju Hyun KIL, Incheon (KR)

(73) Assignee: Korea Electronics Technology Institute, Seongnam-si (KR)

(21) Appl. No.: 18/388,799

(22) Filed: Nov. 10, 2023

(30) Foreign Application Priority Data
Nov. 11, 2022 (KR) 10-2022-0150234

(51) Int. Cl. G06F 9/50

(52) U.S. Cl. CPC G06F 9/5038; G06F 9/5011; G06F 9/5072

(57) ABSTRACT

There is provided a cloud management method and apparatus for available GPU resource scheduling in a large-scale container platform environment. Accordingly, a list of available GPUs may be reflected through a GPU resource metric collected in a large-scale container driving (operating) environment, and an allocable GPU may be selected from the GPU list according to a request, so that GPU resources can be allocated flexibly in response to a GPU resource request of a user (resource allocation reflecting requested resources rather than 1:1 allocation).

CROSS-REFERENCE TO RELATED APPLICATION(S) AND CLAIM OF PRIORITY

This application is based on and claims priority under 35 U.S.C. § 119 to Korean Patent Application No. 10-2022-0150234, filed on Nov. 11, 2022, in the Korean Intellectual Property Office, the disclosure of which is herein incorporated by reference in its entirety.

### BACKGROUND

### Field

The disclosure relates to a method and an apparatus for managing a cloud, and more particularly, to a method and an apparatus for managing a cloud to schedule available graphics processing unit (GPU) resources in a large-scale container platform environment.

### Description of Related Art

In a large-scale container platform environment, there may be a problem that it is difficult to maximize a use rate of a GPU container in which a GPU/IO bottleneck occurs due to various application driving requirements.

In addition, in a related-art large-scale container environment, GPU allocation which is necessary for driving applications for big data analysis and learning may result in fragmentation like a 1:1 allocation method, and technical support such as GPU Direct, GPU Sharing, etc. for effectively utilizing GPS resources in a large-scale container environment may be inadequate, and accordingly, there is a demand for a solution to address this problem.

In addition, diverse GPU resource monitoring and analysis technologies for GPU resource distribution in a large-scale container environment may also be insufficient, and accordingly, there is a need for a solution to address this problem.

### SUMMARY

The disclosure has been developed in order to solve the above-described problems, and an object of the disclosure is to provide a GPU resource scheduling method which flexibly allocates GPU resources in response to a request of a user for GPU resources in a large-scale container driving (operating) environment.

In addition, another object of the disclosure is to provide a GPU resource scheduling method which supports GPU resource overlapping allocation, GPU memory partitioning allocation, and GPU resource allocation over multiple nodes for the sake of flexible GPU resource allocation.

According to an embodiment of the disclosure to achieve the above-described objects, a cloud management method may include: a step of collecting, by a cloud management device, data for allocating GPU resources in a large-scale container operating environment; a step of generating, by the cloud management device, a multi-metric based on the collected data; a step of, when a new pod is generated based on the multi metric, setting, by the cloud management device, a scheduling priority for the generated pod; and a step of performing, by the cloud management device, a scheduling operation for allocating GPU resources according to the set scheduling priority.

In addition, the step of setting the scheduling priority may include, when a new pod is generated, setting a scheduling priority for the generated pod by reflecting a priority set by a user and a number of times of trying rescheduling.

In addition, the step of performing the scheduling operation may include, when performing the scheduling operation, performing a node filtering operation, a GPU filtering operation, a node scoring operation, and a GPU scoring operation.

In addition, the step of performing the scheduling operation may include, when performing the GPU filtering operation and the GPU scoring operation, reflecting a number of GPU requests set by a user and a requested GPU memory capacity.

In addition, the step of performing the scheduling operation may include: determining whether the number of GPU requests set by the user is physically satisfiable; when it is determined that the number of GPU requests is physically satisfiable, performing a GPU filtering operation and a GPU scoring operation with respect to an available GPU; and allocating GPU resources based on a result of the GPU filtering operation and the GPU scoring operation.

The step of performing the scheduling operation may include, when it is determined that a total number of GPU requests set for a plurality of pods, respectively, is physically unsatisfiable, identifying a partitionable GPU memory, partitioning one GPU memory into a plurality of GPU memories, and allocating the plurality of partitioned GPU memories to a plurality of pods to allow the plurality of pods to share one physical GPU device.

In addition, the step of performing the scheduling operation may include, when it is determined that the number of GPU requests is physically unsatisfiable, identifying a partitionable GPU memory, partitioning one GPU memory into a plurality of GPU memories, and allocating a part or all of the plurality of partitioned GPU memories to the pod.

In addition, the step of performing the scheduling operation may include, when it is determined that the number of GPU requests is physically unsatisfiable, identifying a pre-set user policy, and, when multi-node allocation is allowed, allocating a GPU over multiple nodes to satisfy the number of GPU requests.

In addition, the step of collecting data may include collecting GPU resources including GPU utilization, GPU memory, GPU clock, GPU architecture, GPU core, GPU power, GPU temperature, GPU process resource, GPU NVlink pair, GPU return, and GPU assignment.

According to another embodiment of the disclosure, a computer-readable recording medium may have a computer program recorded thereon to perform a cloud management method, the method including: a step of collecting, by a cloud management device, data for allocating GPU resources in a large-scale container operating environment; a step of generating, by the cloud management device, a multi-metric based on the collected data; a step of, when a new pod is generated based on the multi metric, setting, by the cloud management device, a scheduling priority for the generated pod; and a step of performing, by the cloud management device, a scheduling operation for allocating GPU resources according to the set scheduling priority.

In addition, according to still another embodiment of the disclosure, a cloud management device may include: a communication unit configured to collect data for allocating GPU resources in a large-scale container operating environment; and a processor configured to generate a multi-metric based on the collected data, when a new pod is generated based on the multi metric, to set a scheduling priority for the generated pod, and to perform a scheduling operation for allocating GPU resources according to the set scheduling priority.

In addition, according to yet another embodiment of the disclosure, a cloud management system may include: a cloud platform including a plurality of clusters; and a cloud management device configured to collect data for allocating GPU resources in a large-scale container operating environment, to generate a multi-metric based on the collected data, when a new pod is generated based on the multi metric, to set a scheduling priority for the generated pod, and to perform a scheduling operation for allocating GPU resources according to the set scheduling priority.

According to embodiments of the disclosure as described above, a list of available GPUs may be reflected through a GPU resource metric collected in a large-scale container driving (operating) environment, and an allocable GPU may be selected from the GPU list according to a request, so that GPU resources can be allocated flexibly in response to a GPU resource request of a user (resource allocation reflecting requested resources rather than 1:1 allocation).

According to embodiments of the disclosure, by supporting GPU resource overlapping allocation, GPU memory partitioning allocation, and GPU resource allocation over multiple nodes for flexible GPU resource allocation, scheduling may be performed to combine GPU resources to meet a requested GPU size of a container (pod) according to a condition of a GPU mounted in a worker node in a cluster, and scheduling may be performed to adjust a priority of a waiting container when there is no appropriate GPU resource.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain a configuration of a cloud system according to an embodiment of the disclosure;

FIG. 2 is a view provided to explain a detailed configuration of a cloud platform according to an embodiment of the disclosure;

FIG. 3 is a view provided to explain a detailed configuration of a cloud management device according to an embodiment of the disclosure;

FIG. 4 is a view provided to explain a GPU scheduler according to an embodiment of the disclosure;

FIG. 5 is a view illustrating a related-art GPU resource scheduling method;

FIG. 6 is a view illustrating GPU resource overlapping allocation, GPU memory partitioning allocation, GPU resource allocation over multiple nodes which are supported for flexible GPU resource allocation according to an embodiment of the disclosure; and

FIG. 7 is a flowchart provided to explain a GPU resource scheduling method according to an embodiment of the disclosure.

### DETAILED DESCRIPTION

Hereinafter, the disclosure will be described in more detail with reference to the accompanying drawings.

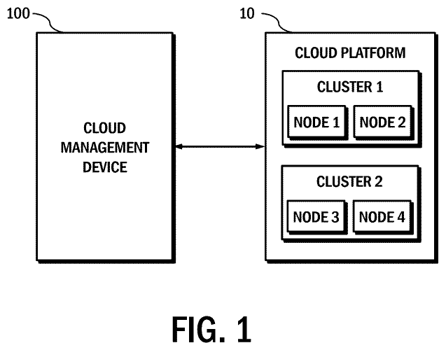

FIG. 1 is a view provided to explain a configuration of a cloud system according to an embodiment of the disclosure.

A cloud system according to an embodiment is provided to flexibly allocate GPU resources in response to a GPU resource request of a user in a large-scale container driving (operating) environment.

To achieve this, a cloud platform 10 in the cloud system may be managed by a cloud management device 100 as shown in FIG. 1.

Specifically, the cloud management device 100 may collect data for allocating GPU resources in a large-scale container operating environment, may generate a multi-metric based on the collected data, may set a scheduling priority for a generated pod when a new pod is generated based on the multi-metric, and may perform a scheduling operation for allocating GPU resources according to the set scheduling priority.

Herein, the cloud management device 100 may be implemented as a physically independent device, may be implemented as being included in a certain device, a system, or a cloud as a part thereof, or may be implemented in the form of software such as a program, a platform, a framework or an application which is installed in a smartphone, a computer, a server, or a cloud. Respective components of the cloud management device 100 may be implemented by physical components or may be implemented by components in the form of a function of software.

The cloud platform 10 may be a platform that is comprised of a plurality of servers to provide a cloud service through virtualization, and may be implemented by Docker or Kubernetes, and may be established as a distributed, cooperative container platform environment.

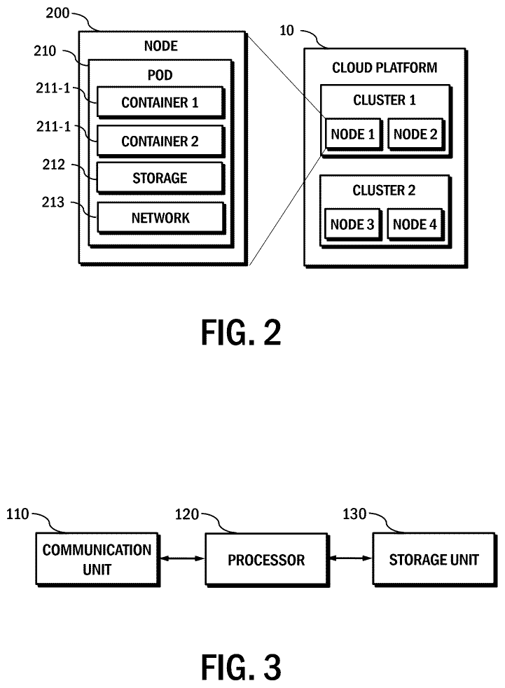

As shown in FIGS. 1 to 2, the cloud platform 10 may be comprised of a plurality of clusters, and one cluster may include a plurality of nodes. At least one pod may be included in each node.

Herein, the cluster may be a plurality of servers that are virtualized to look like one server, and may be positioned in each region. Specifically, the cloud platform 10 of FIG. 1 includes cluster 1 and cluster 2, which are positioned in different regions and zones.

Herein, the region may refer to a continent and the zone may refer to a country.

In addition, one cluster may include a plurality of nodes. A node refers to a server unit based on which a real service (or container) is executed. The node performs a role of generating a service and managing a service state, and may include a plurality of pods.

The cloud platform 10 of the above-described structure may perform a function of allocating resources for executing a specific service to a node that is determined by the cloud management device 100.

In addition, the cloud management device 100 may perform a function of a master to manage all clusters. All commands may invoke an API server of the cloud management device 100 which is a master, and a node may perform a necessary operation while communicating with the cloud management device 100. When a user gives a command to a container of a specific node or inquires a log, the user may give the command to the cloud management device 100, rather than directly giving the command to the node, such that the cloud management device 100 accesses the node and responds to the command instead.

A node may include at least one pod and a structure of such a node will be described in detail with reference to FIG. 2. FIG. 2 is a view illustrating a detailed configuration of the cloud platform 10 according to an embodiment.

As shown in FIG. 2, the cloud platform 10 may include a plurality of nodes 200 and may include at least one pod 210 in each node.

The node 200 may generate a necessary pod 210 while communicating with the cloud management device 100, and may set a network 215 and a storage 213.

The pod 210 is a smallest distribution unit and is where real containers are generated. The pod 210 may be generated and managed by a controller or a replica set, and may be extended to hundreds of pods or thousands of pods. The pod 210 may be given a label to define a using purpose (GPU-specific node, an SSD server). The POD 210 is the smallest unit that is distributed by Kubernetes, and may have attributes of one or more containers 211, and the storage 213 and the network 215. At least one container 211 belonging to the pod 210 may share the storage 213 and the network 215, and may access a local host with each other.

The cloud platform 10 may include a plurality of clusters, a plurality of nodes, and a plurality of pods which are structured as described above.

Hereinafter, a configuration of the cloud management device 100 will be described in detail with reference to FIG. 3. FIG. 3 is a view illustrating the cloud management device 100 according to an embodiment.

As shown in FIG. 3, the cloud management device 100 may include a communication unit 110, a processor 120, and a storage unit 130.

The communication unit 110 is a communication means for transmitting and receiving data necessary for operating the processor 120, and may perform communication in a wireless communication method or a wired communication method.

For example, the communication unit 110 may collect data for allocating GPU resources in a large-scale container operating environment.

That is, the communication unit 110 may be communicably connected with the cloud platform 10 in a large-scale container operating environment, and may collect data for allocating GPU resources and may receive a resource allocation request for a specific service.

Herein, data for allocating GPU resources may include GPU utilization, GPU memory, GPU clock, GPU architecture, GPU core, GPU power, GPU temperature, GPU process resource, GPU NVlink pair, GPU return, and GPU assignment.

In addition, a resource allocation request for a specific service may include information on resources necessary for the corresponding service, and specifically, a resource allocation request for a specific service may include at least one of API version information, type information, label information, CPU requirement, memory requirement, storage requirement, policy information, limited number of times of fault occurrence, and regional information.

In addition, a resource allocation request for a specific service may further include information on a weighting for each type of resource.

The storage unit 130 may store a program and data necessary for operating the processor 120.

The processor 120 may control overall operations of the cloud management device 100.

Specifically, the processor 120 may generate a multi-metric based on collected data, may set a scheduling priority for a generated pod when a new pod is generated based on the multi-metric, and may perform a scheduling operation for allocating GPU resources according to the set scheduling priority.

For example, in the process of performing a scheduling operation for allocating GPU resources according to a set scheduling priority, the processor 120 may determine whether the number of GPU requests set by a user is physically satisfiable, and, when the number of available GPUs is larger than the number of GPU requests set by the user and hence the number of GPU requests is physically satisfiable, the processor 120 may perform a GPU filtering operation and a GPU scoring operation with respect to available GPUs, and may allocate GPU resources based on a result of performing the GPU filtering operation and the GPU scoring operation.

In addition, the processor 120 may determine whether the number of GPU requests set by the user is physically satisfiable, and, when it is determined that the number of GPU requests requested by the user is larger than the number of available GPUs and hence is not physically satisfiable, the processor 120 may partition a GPU memory and allocate partitions of the GPU memory, or may allocate GPU resources over multiple nodes, so that idle resources and a waiting time can be minimized and limitation of hardware can be overcome.

Specifically, when it is determined that the number of GPU requests requested by the user is larger than the number of available GPUs and hence is not physically satisfiable, the processor 120 may identify a GPU memory which can be partitioned, and may partition one GPU memory into a plurality of GPU memories, and may allocate a part or all of the plurality of partitioned GPU memories to a pod or may reserve.

In addition, when it is determined that the number of GPU requests requested by the user is larger than the number of available GPUs and hence is not physically satisfiable, the processor 120 may identify a pre-set user policy, and when multi-node allocation is allowed, the processor 120 may allocate GPU resources over multiple nodes, so that the number of GPU requests can be satisfied.

In another example, the processor 120 may determine whether the total number of GPU requests set for a plurality of pods (user operations), respectively, is physically satisfiable, and, when it is determined that the total number of GPU requests is larger than the number of available GPUs and hence is not physically satisfiable, the processor 120 may allocate GPU resources by overlapping, so that limitation of hardware can be overcome.

Specifically, when it is determined that the total number of GPU requests is larger than the number of available GPUs and hence is not physically satisfiable, the processor 120 may identify a GPU memory which can be partitioned, and may partition one GPU memory into a plurality of GPU memories, and may allocate the plurality of partitioned GPU memories to a plurality of pods partitively, so that the plurality of pods can share one physical GPU device.

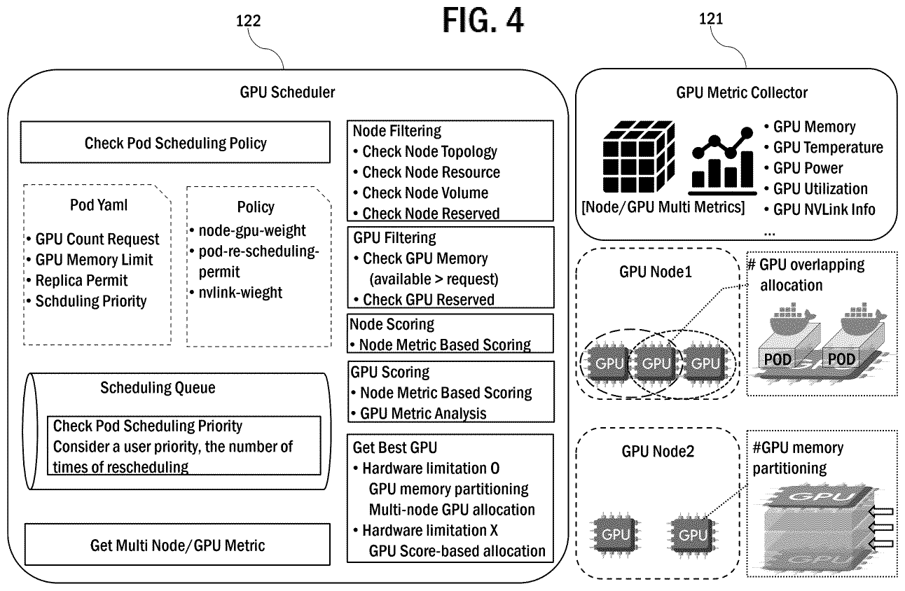

FIG. 4 is a view provided to explain a GPU scheduler 122 according to an embodiment.

The processor 120 may include a GPU metric collector 121 and a GPU scheduler 122 to perform operations described above with reference to FIG. 3.

The GPU metric collector 121 may generate a multi-metric based on data collected for allocating GPU resources.

The GPU scheduler 122 may support scheduling policy setting and may determine a weighting and whether to perform rescheduling according to a corresponding policy.

Specifically, when a user generates a new pod, the GPU scheduler 122 may set a scheduling priority for the generated pod by reflecting a priority set by the user and the number of times of trying rescheduling.

Specifically, when a new pod is generated, the pod (the generated pod) waiting for scheduling is transmitted to a scheduling queue, and, for pods in the scheduling queue, a scheduling priority may be calculated by the GPU scheduler 122 by considering a priority set by the user and the number of times of trying rescheduling.

When a scheduling operation is performed on a node and a GPU, a filtering operation and a scoring operation may be performed by the GPU scheduler 122 based on the collected multi-metric, and the number of GPU requests and a memory request capacity which are designated when a user generates a pod may be reflected when a GPU filtering operation and a GPU scoring operation are performed.

Specifically, when performing a scheduling operation, the GPU scheduler 122 may perform: a node filtering operation to filter a node that makes service deployment impossible by reflecting the number of GPU requests set by a user and a memory CPU request capacity; a GPU filtering operation to filter a GPU that makes service deployment impossible among GPUs belonging to each node remaining after the node filtering operation; a node scoring operation to perform scoring by using a multi-metric for each node remaining after the node filtering operation; and a GPU scoring operation to perform scoring by using a multi-metric for each GPU remaining after the GPU filtering operation.

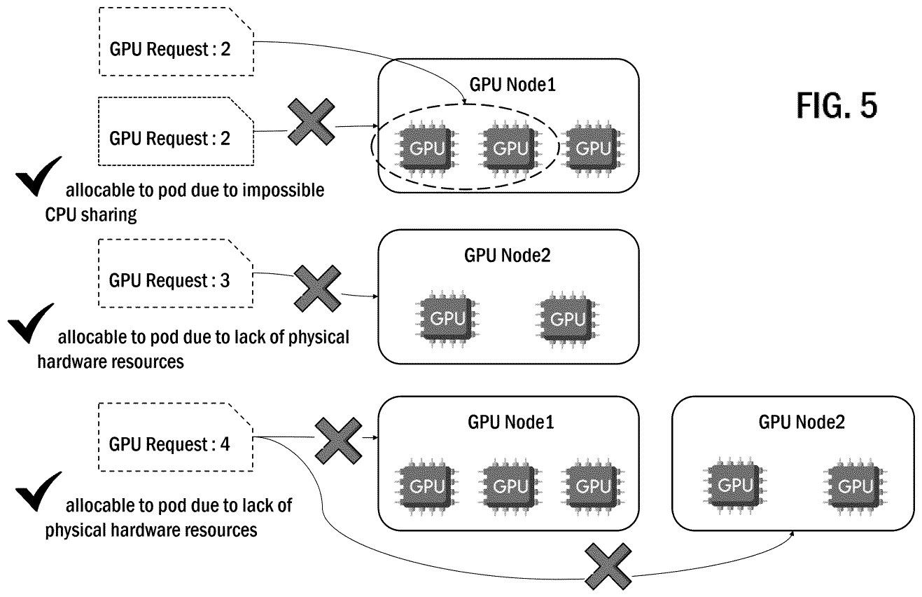

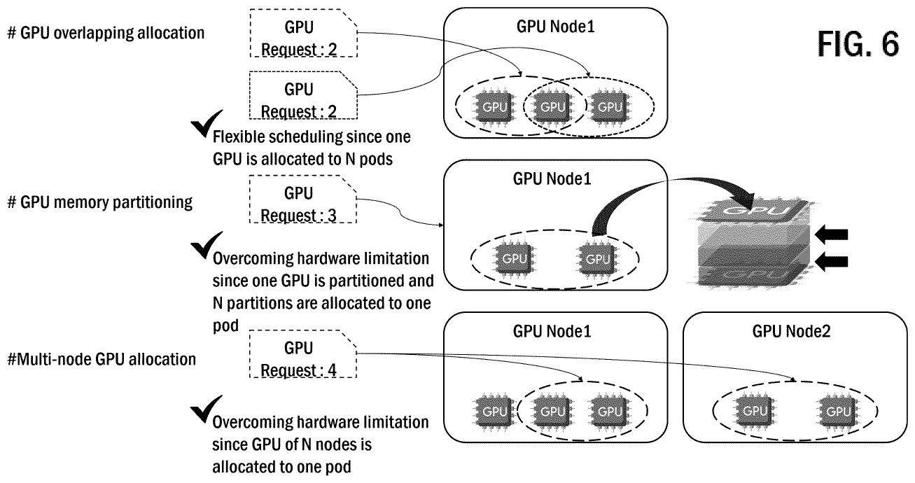

FIG. 5 is a view illustrating a related-art GPU resource scheduling method, and FIG. 6 is a view illustrating GPU resource overlapping allocation, GPU memory partitioning allocation, and GPU resource allocation over multiple nodes which are supported for flexible GPU resource allocation according to an embodiment.

In the related-art Kubernetes platform which manages a container environment, there is a scheduler that performs scheduling for a container, but such a related-art scheduler is not appropriate for scheduling for a container which uses GPU resources.

For example, when the number of GPU requests requested by a user is larger than the number of available GPUs and hence is not physically satisfiable as shown in FIG. 5, the related-art scheduler may have a problem that it is impossible to share a GPU and to allocate resources to pods.

That is, the related-art scheduler does not support GPU sharing, and accordingly, even if there are available resources, two or more pods cannot use corresponding resources and resources may be wasted, and, when the number of GPUs is physically insufficient, the requests may not be satisfied and scheduling may fail.

In addition, when the number of GPU requests requested by a user is larger than the number of available GPUs and hence is not physically satisfiable as shown in FIG. 5, the related-art scheduler may have a problem that it is impossible to allocate resources to pods due to the lack of physical hardware resources.

According to an embodiment, the GPU scheduler 122 may determine whether the number of GPU requests set by a user is physically satisfiable, and, when it is determined that the number of GPU requests is larger than the number of available GPUs and hence is not physically satisfiable, the GPU scheduler 122 may partition a GPU memory and may allocate partitioned GPU memories, or may allocate GPU resources over multiple nodes, so that idle resources and a waiting time can be minimized and limitation of hardware can be overcome.

Specifically, in a process of performing a scheduling operation to allocate GPU resources according to a set scheduling priority, the GPU scheduler 122 may determine whether the number of GPU requests set by a user is physically satisfiable, and, when the number of available GPUs is larger than the number of GPU requests set by the user and hence the number of GPU requests is physically satisfiable, the GPU scheduler 122 may perform a GPU filtering operation and a GPU scoring operation with respect to the available GPUs, and may allocate GPU resources based on a result of the GPU filtering operation and the GPU scoring operation. On the other hand, when the number of GPU requests of the user and a requested capacity are not physically satisfiable, the GPU scheduler 122 may provide a function of identifying a GPU the memory of which can be partitioned and of partitioning one GPU into a plurality of GPUs and allocating the partitioned GPUs to pods.

Specifically, when the number of GPU requests requested by the user is larger than the number of GPUs and hence is not physically satisfiable, the GPU scheduler 122 may identify a GPU memory that can be partitioned, may partition one GPU memory into a plurality of GPU memories (GPU memory partitioning function), and may allocate a part or all of the plurality of partitioned GPU memories (multi instance CPU) to a pod or may reserve.

In addition, when inter-pod GPU sharing is supported and a user allows multiple node allocation, a GPU may be allocated over multiple nodes, so that the number of GPU requests can be satisfied.

Specifically, when it is determined that the number of GPU requests requested by the user is larger than the number of available GPUs and hence is not physically satisfiable, the GPU scheduler 122 may identify a pre-set user policy, and, when multi-node allocation is allowed, the GPU scheduler 122 may allocate GPUs over multiple nodes (multi-node GPU allocation function), so that the number of GPU requests can be satisfied.

In another example, the GPU scheduler 122 may determine whether the total number of GPU requests set for a plurality of pods (user operation), respectively, is physically satisfiable, and, when it is determined that the total number of GPU requests is larger than the number of available GPUs and hence is not physically satisfiable, the GPU scheduler 122 may allocate GPU resources by overlapping (supporting inter-pod GPU sharing), so that limitation of hardware can be overcome.

Specifically, when it is determined that the total number of GPU requests is larger than the number of available GPUs and hence is not physically satisfiable, the GPU scheduler 122 may identify a GPU memory that can be partitioned, and may partition one GPU memory into a plurality of GPU memories, and may allocate the plurality of partitioned GPU memories to a plurality of pods, so that the plurality of pods can share one physical GPU device (GPU overlapping (partitioning?) allocation function).

In the case of GPU overlapping allocation, when one physical GPU device is already allocated to another service but there still remain available resources, GPU resource partitioning allocation may be achieved by sharing the resources with a new pod.

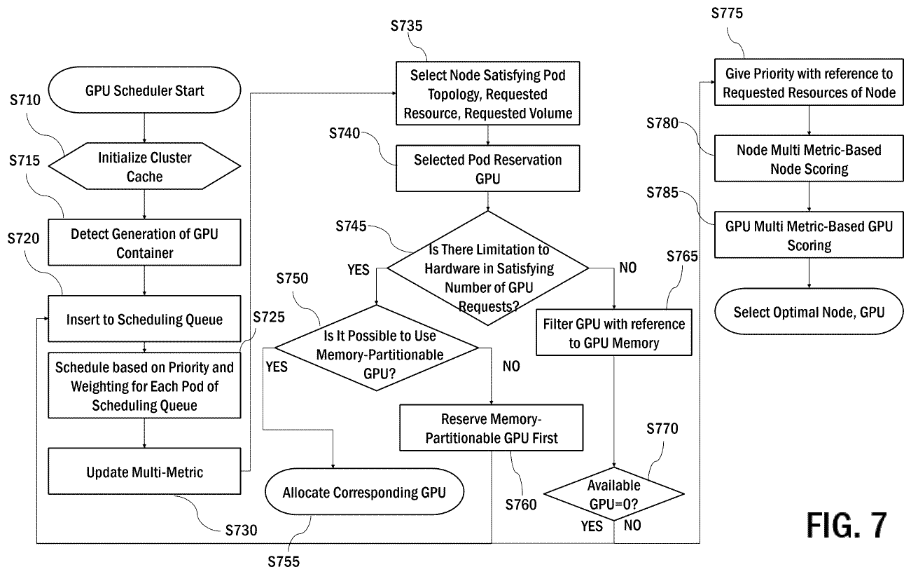

FIG. 7 is a flowchart provided to explain a GPU resource scheduling method according to an embodiment.

The GPU resource scheduling method according to an embodiment is one of cloud management methods executed by the cloud management device.

When a new pod is generated as described above, the cloud management device may set a scheduling priority for the generated pod and may perform a scheduling operation to allocate GPU resources according to the set scheduling priority by using the GPU scheduler 122.

Specifically, the cloud management device may initialize a cluster cache (S710) and may detect generation of a GPU container (pod) (S715), and, when a pod is generated, may insert (transmit) the generated pod to a scheduling queue (S720), and may perform a scheduling operation by reflecting a priority and a weighting set for each pod (S725).

The cloud management device may update a generated multi-metric (S730), and may select a node that satisfies a pod topology, a requested resource, a requested volume (volume capacity) by using the GPU scheduler 122 (S735).

In this case, the GPU scheduler 122 may identify the number of GPU requests set for a corresponding pod according to a scheduling priority (S740), and may determine whether there is a limitation to hardware (a request is physically unsatisfiable) by comparing the number of GPU requests and the number of available GPUs (S745).

When it is determined that the number of GPU requests is physically unsatisfiable (S745-Yes), the GPU scheduler 122 may determine whether it is possible to use a GPU memory that can be partitioned (S750), and, when it is possible to use a GPU memory that can be partitioned (S750-Yes), the GPU scheduler 122 may partition one GPU memory into a plurality of GPU memories, and may allocate a part or all of the plurality of partitioned GPU memories to the pod (S755).

On the other hand, when it is impossible to use a GPU memory that can be partitioned (S750-No), the GPU scheduler 122 may reserve the use of a GPU that can be partitioned first (S760).

The GPU scheduler 122 may determine whether there is a limitation to hardware (a request is physically unsatisfiable) (S745), and, when it is determined that the request is physically satisfiable (S745-NO), the GPU scheduler 122 may perform a GPU filtering operation to filter a GPU that makes service deployment impossible with reference to a GPU memory (S765).

When there exists a GPU that makes service deployment possible (S770-NO), the GPU scheduler 122 gives a priority with reference to a requested resource capacity of the node (S775), may perform a node scoring operation based on a node multi-metric (S780), and then, may perform a GPU scoring operation based on a GPU multi-metric to select an optimal node and GPU for service deployment.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A cloud management method comprising:
a step of collecting, by a cloud management device, data for allocating GPU resources in a large-scale container operating environment;
a step of generating, by the cloud management device, a multi-metric based on the collected data;
a step of, when a new pod is generated based on the multi metric, setting, by the cloud management device, a scheduling priority for the generated pod; and
a step of performing, by the cloud management device, a scheduling operation for allocating GPU resources according to the set scheduling priority.

2. The cloud management method of claim 1, wherein the step of setting the scheduling priority comprises, when a new pod is generated, setting a scheduling priority for the generated pod by reflecting a priority set by a user and a number of times of trying rescheduling.

3. The cloud management method of claim 1, wherein the step of performing the scheduling operation comprises, when performing the scheduling operation, performing a node filtering operation, a GPU filtering operation, a node scoring operation, and a GPU scoring operation.

4. The cloud management method of claim 3, wherein the step of performing the scheduling operation comprises, when performing the GPU filtering operation and the GPU scoring operation, reflecting a number of GPU requests set by a user and a requested GPU memory capacity.

5. The cloud management method of claim 4, wherein the step of performing the scheduling operation comprises:
determining whether the number of GPU requests set by the user is physically satisfiable;
when it is determined that the number of GPU requests is physically satisfiable, performing a GPU filtering operation and a GPU scoring operation with respect to an available GPU; and
allocating GPU resources based on a result of the GPU filtering operation and the GPU scoring operation.

6. The cloud management method of claim 5, wherein the step of performing the scheduling operation comprises, when it is determined that a total number of GPU requests set for a plurality of pods, respectively, is physically unsatisfiable, identifying a partitionable GPU memory, partitioning one GPU memory into a plurality of GPU memories, and allocating the plurality of partitioned GPU memories to a plurality of pods to allow the plurality of pods to share one physical GPU device.

7. The cloud management method of claim 5, wherein the step of performing the scheduling operation comprises, when it is determined that the number of GPU requests is physically unsatisfiable, identifying a partitionable GPU memory, partitioning one GPU memory into a plurality of GPU memories, and allocating a part or all of the plurality of partitioned GPU memories to the pod.

8. The cloud management method of claim 5, wherein the step of performing the scheduling operation comprises, when it is determined that the number of GPU requests is physically unsatisfiable, identifying a pre-set user policy, and, when multi-node allocation is allowed, allocating a GPU over multiple nodes to satisfy the number of GPU requests.

9. The cloud management method of claim 1, wherein the step of colleting data comprises collecting GPU resources comprising GPU utilization, GPU memory, GPU clock, GPU architecture, GPU core, GPU power, GPU temperature, GPU process resource, GPU NVlink pair, GPU return, and GPU assignment.

10. A computer-readable recording medium having a computer program recorded thereon to perform a cloud management method, the method comprising:
a step of collecting, by a cloud management device, data for allocating GPU resources in a large-scale container operating environment;
a step of generating, by the cloud management device, a multi-metric based on the collected data;
a step of, when a new pod is generated based on the multi metric, setting, by the cloud management device, a scheduling priority for the generated pod; and
a step of performing, by the cloud management device, a scheduling operation for allocating GPU resources according to the set scheduling priority.

11. A cloud management device comprising:
a communication unit configured to collect data for allocating GPU resources in a large-scale container operating environment; and
a processor configured to generate a multi-metric based on the collected data, when a new pod is generated based on the multi metric, to set a scheduling priority for the generated pod, and to perform a scheduling operation for allocating GPU resources according to the set scheduling priority.
